(19) United States
(12) Patent Application Publication
(10) Pub. No.: US 2025/0258043 A1
(43) Pub. Date: Aug. 14, 2025

(54) CONTROL PANEL THERMAL DETECTION

(71) Applicant: Ademco Inc., Golden Valley, MN (US)

(72) Inventors: Albert Lee, Brooklyn, NY (US); James Ramroop, Bellport, NY (US); Jaime Barahona, Hempstead, NY (US); Howard Yuk, Meadow, NY (US)

(73) Assignee: Ademco Inc., Golden Valley, MN (US)

(21) Appl. No.: 18/859,625

(22) PCT Filed: Apr. 28, 2023
(86) PCT No.: PCT/US2023/020329

§ 371 Date: Oct. 24, 2024

Related U.S. Application Data
(60) Provisional application No. 63/341,013, filed on May 12, 2022.

(51) Int. Cl. G01K 3/00; G01K 7/22; G08B 25/14

(52) U.S. Cl. CPC G01K 3/005; G01K 7/22; G08B 25/14

(57) ABSTRACT

A method includes measuring a first temperature at a control panel using a temperature sensor included at a battery of the control panel. When the first temperature at the control panel exceeds a predetermined threshold temperature, this method includes transitioning the control panel to a reduced operational mode. When the control panel is in the reduced operational mode, this method includes measuring a second temperature at the control panel using the temperature sensor included at the battery of the control panel. And, when the second temperature at the control panel exceeds the predetermined threshold temperature, this method includes outputting an abnormal temperature notification at the control panel.

### TECHNICAL FIELD

This disclosure relates generally to thermal detection techniques and related devices and systems, for instance, a control panel, for use in home automation, comfort, and security system networks, configured to detect one or more abnormal temperature conditions and cause one or more corresponding actions to be taken in relation to detection of one or more abnormal temperature conditions.

### BACKGROUND

Modern premises, such as residential buildings or other buildings, can include a control panel that serves as a central “hub” device configured to manage one or more systems within the building, such as monitoring systems, comfort systems, security systems, and/or home automation systems. The control panel can be in wireless communication with a number of sensor devices placed throughout the building. For example, the control panel can wirelessly receive sensor data from any number of different sensor devices, such as motion sensors, air quality and/or temperature sensors, infrared sensors, door and/or window contact sensors, switches, and/or other sensor devices. Additionally, the control panel cam wirelessly transmit commands or instructions to one or more controllable sensor devices.

To prevent damage and ensure intended premises system operation, the control panel typically needs to operate within a specified temperature range. Operation within this specified temperature range can reduce the likelihood of damage to components at the control panel and, thereby, help to ensure these components perform their intended function. An abnormal temperature condition at the control panel, including an abnormal temperature condition at the ambient environment of the premises at which the control panel is deployed, can result from internal electrical operation of the control panel and/or environmental conditions at the ambient environment of the premises at which the control panel is deployed.

### SUMMARY

In general, this disclosure relates to devices, systems, and methods for thermal detection. Embodiments disclosed herein can facilitate temperature detection and, based on this temperature detection, cause one or more actions to be taken to remediate an abnormal temperature condition and/or a notification to be output regarding the abnormal temperature condition. Such embodiments include a control panel configured to detect an abnormal temperature condition at the control panel and cause one or more actions to be taken to reduced a temperature at the control panel and/or output a notification regarding the abnormal temperature condition.

Certain embodiments disclosed herein can facilitate this useful thermal detection function without substantially increasing the cost associated with the control panel and even allowing for this this useful thermal detection function to be implemented as a type of retrofit at existing control panels currently deployed at premises. For instance, certain such embodiments can use a temperature sensor, such as a thermistor, included at a battery (e.g., backup battery) of the control panel to detect an abnormal temperature condition at the control panel. In many such embodiments, the control panel can already include a temperature sensor at the battery of the control panel, so such embodiments can leverage this existing temperature sensor, often used to detect the battery's charging temperature, to also detect an abnormal temperature condition at the control panel and, thereby, facilitate increased functionality for detecting an abnormal temperature condition at the control panel without necessitating additional components (e.g., a dedicated temperature sensor in addition to the temperature sensor at the battery) that would otherwise add cost and make retrofitting such functionality at existing control panels impractical. This abnormal temperature condition detection functionality can be especially useful at a control panel deployed in the home security, comfort, and/or automation system since the control panel can be a type of hub device often critical for communicating data within the system and causing system actions to be carried out.

Notably, because various embodiments can leverage an existing temperature sensor (e.g., thermistor) at the battery of the control panel, various such embodiments can execute abnormal thermal detection capability that takes into account certain operational conditions at the control panel that can generate heat at the control panel. This can increase the accuracy of the abnormal thermal detection capability by removing certain operational conditions, which can dissipate heat when being executed, at the control panel from consideration when measuring a temperature at the control panel. Accordingly, abnormal thermal detection techniques disclosed herein can account for the use of existing temperature sensor (e.g., thermistor) at the battery of the control panel by isolating certain aspects of abnormal thermal detection to those operational conditions at the control panel likely to facilitate a more accurate thermal detection that is not materially impacted by heat generation and dissipation occurring during normal control panel operation.

One embodiment includes a method. This method embodiment includes the step of measuring a first temperature at a control panel using a temperature sensor included at a battery of the control panel. When the first temperature at the control panel exceeds a predetermined threshold temperature, this method embodiment includes transitioning the control panel to a reduced operational mode. When the control panel is in the reduced operational mode, this method embodiment includes measuring a second temperature at the control panel using the temperature sensor included at the battery of the control panel. And, when the second temperature at the control panel exceeds the predetermined threshold temperature, this method embodiment includes outputting an abnormal temperature notification at the control panel.

In a further embodiment of this method, the reduced operational mode of the control panel produces less heat locally at the control panel than a normal operational mode of the control panel.

In a further embodiment of this method, transitioning the control panel to the reduced operational mode includes at least one of: terminating charging of the battery, dimming a user interface at the control panel, reducing an operating frequency of processing circuitry at the control panel, and turning off a wireless transmitter at the control panel. For example, transitioning the control panel to the reduced operational mode can include each of dimming the user interface at the control panel and reducing the operating frequency of processing circuitry at the control panel.

In a further embodiment of this method, the control panel is transitioned to the reduced operational mode both when the first temperature at the control panel exceeds the predetermined threshold temperature and after the control panel has determined a lack of an alarm condition.

In a further embodiment of this method, when the second temperature at the control panel exceeds the predetermined threshold temperature, the method includes maintaining the control panel in the reduced operational mode.

In a further embodiment of this method, the method additionally includes, when the control panel is in the reduced operational mode, measuring a third temperature at the control panel using the temperature sensor included at the battery of the control panel. For example, when the third temperature at the control panel is below the predetermined threshold temperature, the method can include transitioning the control panel from the reduced operational mode to a normal operational mode, where the normal operational mode consumes more power than the reduced operational mode. For instance, the control panel can be in the normal operational mode when the first temperature at the control panel is measured. As another example, when the third temperature at the control panel can exceed a second predetermined threshold temperature that is greater than the predetermined threshold temperature, the method can include shutting down operation of the control panel.

In a further embodiment of this method, the temperature sensor can be a thermistor at the battery. For example, the battery can be a rechargeable battery (e.g., a backup rechargeable battery), and the thermistor can be embedded at the battery to measure a temperature of the battery when the battery is being charged in addition to the temperature at the control panel. In such an example, the first temperature at the control panel can be measured when the battery is not being charged. Likewise, in such an example, the first temperature at the control panel can be measured when the control panel has determined a lack of an alarm condition.

In a further embodiment of this method, outputting the abnormal temperature notification at the control panel can include sending the abnormal temperature notification to a remote device.

In a further embodiment of this method, outputting the abnormal temperature notification at the control panel can include providing an abnormal temperature alert locally at the control panel.

In a further embodiment of this method, the method can include, when the control panel is in the reduced operational mode, measuring a third temperature at the control panel using the temperature sensor included at the battery of the control panel. This method can further include determining a rate of increase of the temperature at the control panel using at least the second temperature and the third temperature each measured when the control panel is in the reduced operational mode. When the rate of increase of the temperature at the control panel is below a predetermined threshold temperature rate of increase, the method includes outputting an abnormal temperature warning at the control panel. And, when the rate of increase of the temperature at the control panel is above the predetermined threshold temperature rate of increase, the method includes outputting an abnormal temperature critical alert at the control panel.

Another embodiment includes a control panel. In this embodiment, the control panel includes processing circuitry, a battery coupled to the processing circuity, and a temperature sensor at the battery and coupled to the processing circuitry. The processing circuitry is configured to: receive, from the temperature sensor at the battery, a first temperature at the control panel; when the first temperature at the control panel exceeds a predetermined threshold temperature, transition the control panel to a reduced operational mode; when the control panel is in the reduced operational mode, receive, from the temperature sensor at the battery, a second temperature at the control panel; and, when the second temperature at the control panel exceeds the predetermined threshold temperature, output an abnormal temperature notification at the control panel.

In a further embodiment of this control panel, the control panel further includes a user interface coupled to the processing circuity. And, the processing circuity can be further configured to transition the control panel to the reduced operational mode by each of dimming the user interface at the control panel and reducing an operating frequency of the processing circuitry at the control panel.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a conceptual block diagram illustrating an exemplary embodiment of a premises network, in accordance with some examples of this disclosure.

FIG. 2 is a conceptual block diagram illustrating an exemplary embodiment of a control in greater detail, in accordance with some examples of this disclosure.

FIG. 3 is a flow diagram illustrating an exemplary embodiment of a method for thermal detection, in accordance with some examples of this disclosure.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

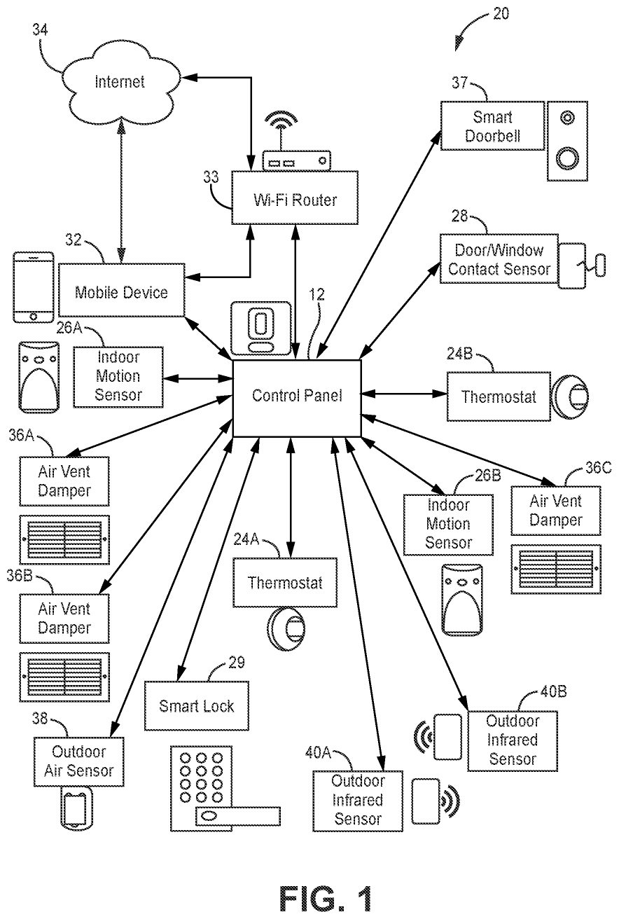

FIG. 1 is a conceptual block diagram illustrating an exemplary embodiment of a premises network 20, in accordance with examples of this disclosure. Various devices, including various types of sensor devices, can be deployed in the network 20. For example, in the network 20, various devices, including various sensor devices, can be in communication with a control panel 12. The control panel 12 can serve as a type of hub device for the network 20 as, in some such embodiments, these devices in the network 20 can be in data communication (e.g., two-way data communication) with the control panel 12 (e.g., using a superframe for communicating data within the network 20). In some examples, the superframe can be a proprietary, manufacturer specific protocol, such a time divisional multiple access (TDMA) superframe, or a standards-based protocol, such as a non-TDMA superframe, for instance a MATTER™ superframe. Network 20 may be installed within a building and/or the surrounding premises (collectively, “premise”).

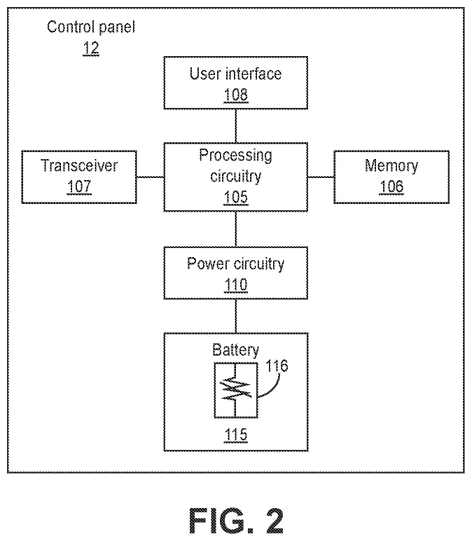

Control panel 12 can include a computing device configured to operate one or more systems within a building, such as comfort, security, safety, and/or home automation systems. For example, as described further below in reference to FIG. 2, control panel 12 can include processing circuitry 105 configured to receive data, such as data received from one or more sensor devices and/or from user input, and process the data in order to automate one or more systems within a building. For example, control panel 12 may automate, control, or otherwise manage systems including heating and cooling, ventilation, illumination, or authorized access to individual rooms or other regions, as non-limiting examples. For example, control panel 12 may include a “Life and Property Safety Hub®” of Resideo Technologies, Inc.®, of Austin, Texas. Control panel 12 can include a wired connection to an electric power grid, and in some examples control panel 12 can include an internal power source, such as a battery 115 that serves as a backup power source in instances where the wired connection to the electric power grid is unavailable. Likewise, this battery 115 can be rechargeable using power from the wired connection.

Devices on the network 20, including sensor devices, can be configured to enroll with control panel 12. For example, a sensor device can be configured to exchange sensor data with control panel 12 and/or be controlled by control panel 12. Sensor devices may be configured to collect or generate sensor data and transmit the sensor data to control panel 12 for processing. In some examples, sensor devices can include a controllable device. A controllable device may be configured to perform a specified function when the controllable device receives instructions (e.g., a command or other programming) to perform the function from control panel 12. Examples of different types of sensor devices that can be included in the network 20 are described below. Sensor devices can include either a wired connection to an electric power grid or an internal power source, such as a battery, supercapacitor, or another internal power source. Although FIG. 1 shows control panel 12 as directly connected to the various devices in the network 20, in some examples, network 20 can include one or more repeater nodes that are each configured to act as an intermediary or “repeater” device.

As shown for the illustrated embodiment of the network 20 at FIG. 1, in addition to control panel 12, the network system 20 can include various devices, including various types of sensor device. Exemplary types of sensor devices that can deployed in the network system include thermostats 24A, 24B (collectively, thermostats 24), indoor motion sensor 26A and outdoor motion sensor 26B (collectively, motion sensors 26), door/window contact sensor 28, air vent damper 36A, 36B, 36C (collectively, air vent dampers 36), smart doorbell 37, outdoor air sensor 38, outdoor infrared sensor 40A, indoor infrared sensor 40B (collectively, infrared sensors 40). In addition to the sensor devices, the network system can include devices such as router 33 and a remote device (e.g., mobile device 32 and/or a remote server). Control panel 12 and one or more of the devices in the networked system 20 can communicate using one or more communication protocols stored at control panel 12 as computer-executable instructions. In some examples, the communication protocol(s) computer-executable instructions stored at control panel 12 can be executed for communication using a same frequency band, such as 2.4 GHz.

Control panel 12 can be in wireless data communication with thermostats 24, motion sensors 26, door/window contact sensor 28, air vent dampers 36, smart doorbell 37, outdoor air sensor 38, and infrared sensors 40. Each of thermostats 24, motion sensors 26, door/window contact sensor 28, air vent dampers 36, smart doorbell 37, outdoor air sensor 38, and infrared sensors 40 may include either a sensor device (e.g., a device configured to collect and/or generate sensor data), a controllable device, or both, as described herein. For example, thermostats 24 may include comfort devices having sensors, such as a thermometer configured to measure an ambient air temperature. In some examples, air vent dampers 36 may include devices located within an air vent or air duct, configured to either open or close the shutters of an air vent in response to receiving instructions from control panel 12.

Thermostats 24 may be configured to wirelessly transmit the temperature (e.g., sensor data) directly to control panel 12. Additionally, thermostats 24 may include controllable devices, in that they may activate or deactivate a heating, cooling, or ventilation system in response to receiving instructions from control panel 12. For example, thermostat 24A may collect temperature data and transmit the data to control panel 12. Control panel 12, in response to receiving the temperature data, may determine that a respective room is either too hot or too cold based on the temperature data, and transmit a command to thermostat 24A to activate a heating or cooling system as appropriate. In this example, each of thermostats 24 may include both sensor devices and controllable devices within a single distinct unit.

Indoor and outdoor motion sensors 26 may include security devices configured to detect the presence of a nearby mobile object based on detecting a signal, such as an electromagnetic signal, an acoustic signal, a magnetic signal, a vibration, or other signal. The detected signal may or may not be a reflection of a signal transmitted by the same device. In response to detecting the respective signal, motion sensors 26 may generate sensor data indicating the presence of an object, and wirelessly transmit the sensor data to control panel 12. Control panel 12 may be configured to perform an action in response to receiving the sensor data, such as outputting an alert, such as a notification to mobile device 32, or by outputting a command for the respective motion sensor 26 to output an audible or visual alert. In this example, each of motion sensors 26 may include both sensor devices and controllable devices within a single unit.

Door and/or window contact sensor 28 may include a security device configured to detect the opening of a door or window on which the door and/or window contact sensor 28 is installed. For example, contact sensor 28 may include a first component installed on a door or window, and a second component installed on a frame of the respective door or window. When the first component moves toward, past, or away from the second component, the contact sensor 28 may be configured to generate sensor data indicating the motion of the door or window, and wirelessly transmit the sensor data to control panel 12. In response to receiving the sensor data, control panel 12 may be configured to perform an action such as outputting an alert, such as a notification to mobile device 32, or by outputting a command for the respective contact sensor 28 to output an audible or visual alert. In this example, contact sensor 28 may include a sensor devices and a controllable devices within a single unit.

Air vent dampers 36 may be configured to regulate a flow of air inside of a duct. For example, thermostats 24 may generate a control signal to close air vent damper 36A (e.g., when the room is not occupied). In this example, in response to the control signal, air vent damper 36 may close to prevent air from flowing from air vent damper 36A. In some examples, air vent dampers 36 may send sensor data indicating a state (e.g., open or closed) of the respective air vent damper. For instance, air vent damper 36 may output, to thermostats 24 an indication that air vent damper 36 is in an open state.

Smart doorbell 37 may be configured to provide notifications to control panel 12. For example, smart doorbell 37 may be configured to provide a notification (e.g., message) when a button (e.g., doorbell) of smart doorbell 37 is activated. In some examples, smart doorbell 37 may include motion sensor circuitry configured to generate a notification in response to motion detected near smart doorbell 37. In some examples, smart doorbell 37 may be configured to generate video content in response to motion detected near smart doorbell 37. In some examples, smart doorbell 37 may be configured to generate audio content in response to motion detected near smart doorbell 37. For instance, in response to motion detected near smart doorbell 37, smart doorbell 37 may generate video content using a camera and/or audio content using a microphone. In this instance, smart doorbell 37 may output the video content and audio content to control panel 12, which may forward the video content and/or audio content to mobile device 32.

Outdoor air sensor 38 may be configured to generate sensor data indicating, for example, a temperature, humidity, and/or quality (e.g., carbon monoxide, particulate matter, or other hazards) of the surrounding air. In some examples, outdoor air sensor 38 may wireless transmit the sensor data to control panel 12. For instance, outdoor air sensor 38 may periodically output a current or average temperature to thermostats 24 via control panel 12.

Outdoor passive infrared sensors 40 may include security devices configured to detect the presence of a nearby object, such as a person, based on detecting infrared wavelength electromagnetic waves emitted by the object. In response to detecting the infrared waves, passive infrared sensors 40 may generate sensor data indicating the presence of the object, and wirelessly transmit the sensor data to control panel 12. Control panel 12 may be configured to perform an action in response to receiving the sensor data, such as outputting an alert, such as a notification to mobile device 32, or by outputting a command for the respective passive infrared sensor 40 to output an audible or visual alert.

Network 20 may include various devices, including, for example, a security device, a water heater, a water flow controller, a garage door controller, or other devices. For example, network 20 may include one or more of: a door contact sensor, a motion passive infrared (PIR) sensor, a mini contact sensor, a key fob, a smoke detector, a glass break detector, a siren, a combined smoke detector and Carbon monoxide (CO) detector, an indoor siren, a flood sensor, a shock sensor, an outdoor siren, a CO detector, a wearable medical pendant, a wearable panic device, an occupancy sensor, a keypad, and/or other devices.

Control panel 12 and each of thermostats 24, motion sensors 26, door/window contact sensor 28, air vent dampers 36, smart doorbell 37, outdoor air sensor 38, and infrared sensors 40 may be configured to operate using a superframe of a selected communication protocol to transmit data, for instance, according to a regular, pre-defined, periodic schedule.

FIG. 2 is a block diagram illustrating an exemplary embodiment of the control panel 12, in accordance with one or more aspects of the techniques described in this disclosure. FIG. 2 illustrates only one particular example of control panel 12, and other examples of a control panel can be used in other instances and can include a subset of the components illustrated as included in example control panel 12 or may include additional components not shown in FIG. 2.

As shown in the example of FIG. 2, control panel 12 includes the processing circuitry 105 and memory 106 that is coupled to processing circuity 105. Processing circuitry 105 can include one or more programmable processors configured to implement functionality and/or execute instructions stored at control panel 12, including thermal detection of an abnormal temperature condition at or near control panel 12. For example, memory 106 and/or processing circuitry 105 itself can be a non-transitory computer-readable storage article storing computer-executable instructions that the processing circuitry 105 is configured to read and execute the specified functionality. Examples of processing circuitry 105 can include application processors, display controllers, auxiliary processors, and any other hardware configure to function as a processor, a processing unit, or a processing device. Memory 106 can be configured to store non-transitory computer executable instructions which processing circuitry 105 can be configured to execute to perform various actions, operations, or functions of control panel 12, including those disclosed herein. For example, processing circuitry 104 of control panel 12 can retrieve and execute instructions stored by memory 106 that cause processing circuity 105 to perform the operations described with respect to embodiments of thermal detection of an abnormal temperature conditions disclosed herein.

Control panel 12 can further include transceiver 107 that is coupled to processing circuity 105. Transceiver 107 can include a wireless transmitter configured to transmit data, control commands, and/or notifications to one or more devices in the network, including to one or more remote devices in the network such as a remote use device (e.g., a mobile computing device) and/or a remote server. Transceiver 107 can also include a wireless receiver configured to receive data, control commands, and/or notifications from one or more devices in the network, including from one or more remote devices in the network.

Control panel 12 can additionally include user interface 108 that is coupled to processing circuity 105. User interface 108 can be configured to display one or more outputs and/or receive one or more user inputs. As one example, user interface 108 can include a display with associated lighting. As one such example, user interface 108 can be a touchscreen with associated lighting (e.g., a liquid crystal touchscreen). User interface 108 can receive an output generated by processing circuitry 105 and display the output generated by processing circuitry. As described further herein, one such output that user interface 108 can display includes display of an abnormal temperature notification at control panel 12. Also, user interface 108 can receive one or more inputs from a user at control panel 12. For example, user interface 108 can receive user input corresponding to one or more instructions for one or more operations to be taken at control panel 12. As a particular such example, when user interface 108 displays an abnormal temperature notification at control panel 12, user interface can receive user input thereat relating to the detected abnormal temperature condition, such as instructions from the user as to one or more actions to be taken at control panel 12 as a result of the detected abnormal temperature condition.

Control panel 12 further includes power circuitry 110 and battery 115. Power circuity 110 and battery 115 are each coupled to processing circuitry 105. Power circuitry 110 can include a wired connection to an electric power grid, such as via an electrical plugged connection to mains wall power at a premise, and can be configured to transform and condition electrical potential from the electrical power grid to a state suitable for use at control panel 12. Battery 115 can be a rechargeable battery that receives and stores power from the wired power connection via power circuitry 110. Because control panel 12 can serve as a type of central hub device for the network, and thus can be needed to convey data and carry out various functions at the network, control panel 12 can include battery 115 as a backup power source in the event wired power from the electric grid via power circuitry 110 becomes unavailable. As such. battery 115 can be a backup battery that can help to ensure sufficient power for operational capability of control panel 12 for a preset period of time (e.g., twenty four hours) and, thereby, help to ensure control panel 12 can operate appropriately in the event of power loss at the premises where control panel 12 is deployed.

Battery 115 can include a temperature sensor 116. Temperature sensor 116 can be coupled to processing circuity 105. Temperature sensor 116 can be included at battery 115 and configured to measure a temperature at control panel 12. For example, processing circuity 105 can cause temperature sensor 116 to take temperature measurements at control panel 12 at periodic points in time, and such periodic temperature measurements can be stored at memory 106 and used by processing circuity 105 to detect an abnormal temperature condition at control panel 12.

In certain embodiments, temperature sensor 116 can be a thermistor at the battery 115. As one example, battery 115 can be a backup, rechargeable battery component installed at control panel 12, and temperature sensor 116 can be a thermistor integrated and embedded at the control panel's backup, rechargeable battery 115 to measure a temperature of battery 115, such as when battery 115 is being charged, in addition to a temperature at control panel 12. Thus, in such an example, certain embodiments disclosed herein can use a temperature sensor component-thermistor-already included at control panel 12 and used for measuring battery 115 temperature during battery charging to also measure a temperature at control panel 12 to detect an abnormal temperature condition at control panel 12. In this way, such embodiments disclosed herein can facilitate detection of an abnormal temperature condition at control panel 12 without needing to include an additional temperature sensing component, but instead can facilitate detection of an abnormal temperature condition at control panel 12 with updated computer-executable instructions to cause processing circuity 105 to carry out one or more of the techniques disclosed herein for abnormal temperature condition detection at control panel 12.

Because control panel 12 itself can dissipate, and otherwise generate, heat during operation of components at control panel 12 and temperature sensor 116 can be configured to measure a temperature at control panel 12, to help leverage an existing temperature sensor (e.g., thermistor) at the battery 115 of control panel 12 to execute abnormal thermal detection capability, embodiments disclosed herein can take into account certain operational conditions at control panel 12 that can dissipate, or otherwise generate, heat at control panel 12 to help increase temperature measurement accuracy at control panel 12 during abnormal temperature condition detection. For instance, such embodiments can do so by removing certain operational conditions, which can dissipate heat when being executed, at control panel 12 from consideration when measuring a temperature at control panel 12 such that temperature measurements used for the detection of an abnormal temperature condition at control panel 12 are taken at times when control panel 12 is producing less heat locally at control panel 12 than in a normal operational mode at control panel 12. Accordingly, abnormal thermal detection techniques disclosed herein can allow for the use of an existing temperature sensor (e.g., thermistor), which is configured to measure battery 115 temperature, such as during rechanging, to also measure temperature at control panel 112 for detection of an abnormal temperature condition at control panel 12 by isolating certain aspects of the abnormal thermal detection so as to reduce or prevent material impact of heat generation and dissipation otherwise occurring during normal operation of control panel 12.

As noted, processing circuitry 105 can be configured to use temperature sensor 116 to perform an abnormal temperature condition detection operation at control panel 12. For example, processing circuitry 105 can be configured to receive, from temperature sensor 116 at battery 115, a first temperature at control panel 12. When the first temperature at control panel 12 exceeds a predetermined threshold temperature, processing circuitry 105 can be configured to transition control panel 12 to a reduced operational mode (e.g., where the reduced operational mode at control panel 12 produces less heat locally at control panel 12 than a normal operational mode of control panel 12). When control panel 12 is in the reduced operational mode, processing circuitry 105 can be configured to receive, from temperature sensor 116 at battery 115, a second temperature at control panel 12. And, when the second temperature at control panel 12 exceeds the predetermined threshold temperature, processing circuitry 105 can be configured to output an abnormal temperature notification at control panel 12.

To help reduce or prevent material impact on temperature measurement, at temperature sensor 116, due to heat generation and dissipation otherwise occurring during normal operation of control panel 12, processing circuitry 105 can be configured to transition control panel 12 to the reduced operational mode. For example, processing circuitry 105 can be configured to transition control panel 12 to the reduced operational mode by at least one of: terminating charging of battery 115, dimming user interface 108 at the control panel 12, reducing an operating frequency of processing circuitry 105 at control panel 12, and turning off a wireless transmitter (e.g., turning off wireless transceiver 107) at control panel 12. One specific such example, processing circuitry 105 can be configured to transition control panel 12 to the reduced operational mode by each of dimming illuminance of user interface 108 at control panel 12 and reducing an operating frequency of processing circuitry 105 at control panel 12.

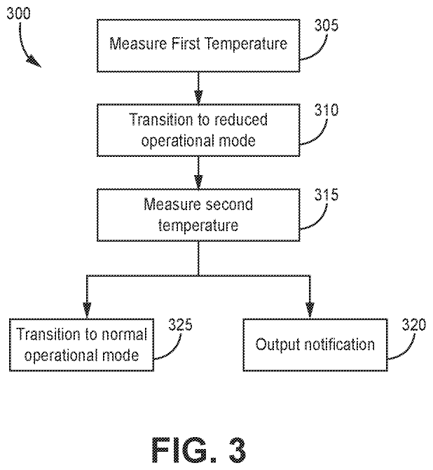

FIG. 3 is a flow diagram of an exemplary embodiment of a method 300. Method 300 can be used, for instance, to detect an abnormal temperature condition, such as at the control panel described previously herein.

At step 305, method 300 includes measuring a first temperature at a control panel using a temperature sensor included at a battery of the control panel. The control panel can, for example, be in a normal operation mode when the first temperature at the control panel is measured at step 305. This can include, for instance, processing circuity at control panel taking no action to alter operation of control panel for the sole purpose of measuring the first temperature at the control panel. In addition or alternatively, the first temperature at the control panel can be measured when the battery is not being charged and/or when the control panel has determined a lack of an alarm condition. For instance, processing circuitry at the control panel can first check that the battery at the control panel is not charging and/or that processing circuity has not determined the presence of an alarm condition at the premises at which the control panel is deployed (e.g., because data from one or more sensors in the premises network does not indicate information indicative of an alarm condition; because data from one or more sensors in the premises network does not satisfy a preprogrammed alarm condition threshold at the control panel) before receiving and storing the first temperature measurement from the temperature sensor at the control panel. This can help the first temperature measurement to better represent a temperature at the control panel corresponding to a malfunctioning component at the control panel and/or an ambient environment proximate the control panel.

At step 310, when the first temperature measurement at the control panel measured at step 305 exceeds a predetermined threshold temperature, method 300 includes transitioning the control panel to a reduced operational mode. The predetermined threshold temperature can be, for instance thirty degrees Celsius, thirty five degrees Celsius, forty degrees Celsius, forty five degree Celsius, or fifty degrees Celsius. The reduced operational mode of the control panel can, for instance, produce less heat locally at the control panel than a normal operational mode of the control panel. As such, transitioning the control panel to the reduced operational mode can result in the control panel producing less heat and/or the control panel operating less components, or components at a lower power consumption level. For example, transitioning the control panel to the reduced operational mode can include at least one of: terminating charging of the battery, dimming a user interface at the control panel (e.g., reducing an illuminance intensity output by one or more (e.g., all) light elements, such as one or more light emitting diodes, at the user interface of the control panel), reducing an operating frequency of processing circuitry at the control panel (e.g., such that data processing at control panel is adjusted to take place less frequently), and turning off a wireless transmitter at the control panel. As one such example. transitioning the control panel to the reduced operational mode can include each of dimming the user interface at the control panel and reducing the operating frequency of processing circuitry at the control panel. As noted, the control panel can be transitioned to the reduced operational mode when the first temperature at the control panel exceeds the predetermined threshold temperature, and in one exemplary case the control panel can be transitioned to the reduced operational mode both when the first temperature at the control panel exceeds the predetermined threshold temperature and after the control panel has determined a lack of an alarm condition.

At step 315, when the control panel is in the reduced operational mode, method 300 includes measuring a second temperature at the control panel using the temperature sensor included at the battery of the control panel. Because the second temperature at the control panel, using the temperature sensor included at the battery of the control panel, is measured at step 315 when the control panel is in the reduced operational mode, the second temperature can provide an indication of a temperature at the control panel that is less impacted by heat dissipation and other operational considerations associated with normal operational mode of the control panel. As such, a relative comparison of the first temperature measurement at step 305 and the second temperature measurement at step 315 can help to assess a contribution of heat dissipation and other operational considerations associated with normal operational mode of the control panel to the measured temperature at the control panel.

At step 320, when the second temperature measurement at the control panel measured at step 315 exceeds the predetermined threshold temperature, method 300 includes outputting an abnormal temperature notification at the control panel. As one example, outputting the abnormal temperature notification at the control panel can include sending the abnormal temperature notification to a remote device, such as a remote user computing device (e.g., smart phone) and/or a remote server (e.g., at a central monitoring station). As another additional or alternative example, outputting the abnormal temperature notification at the control panel can include providing an abnormal temperature alert locally at the control panel, such as at a display of the control panel in the form of an icon or text-based alert shown at the display of the control panel.

In some embodiments of method 300, when the second temperature measurement at the control panel measured at step 315 exceeds the predetermined threshold temperature, method 300 can include maintaining the control panel in the reduced operational mode. And, when the control panel is in the reduced operational mode, method 300 can include measuring a third temperature at the control panel using the temperature sensor included at the battery of the control panel.

Then, at step 325, when the third temperature at the control panel is below the predetermined threshold temperature, method 300 can include transitioning the control panel from the reduced operational mode to the normal operational mode, where the normal operational mode consumes more power than the reduced operational mode at which at least the second and third temperatures were measured.

On the other hand, when the third temperature at the control panel exceeds a second predetermined threshold temperature that is greater than the predetermined threshold temperature, method 300 can include shutting down operation of the control panel. Shutting down operation of the control panel as such can include, for instance, terminating a power supply to the control panel (e.g., disconnecting the battery from the processing circuity, such as via a switch actuated manually by a user or automatically by the processing circuitry).

In some embodiments, a rate of increase of the temperature at the control panel can be used to detect an abnormal temperature condition at the control panel. For example, when the control panel is in the reduced operational mode, for instance as a result of the control panel being transitioned to the reduced operational mode at step 310, and after the second temperature has been measured at the control panel using the temperature sensor included at the battery of the control panel at step 315, method 300 can include measuring a third temperature at the control panel using the temperature sensor included at the battery of the control panel. Then, method 300 can include determining (e.g., via the processing circuitry) a rate of increase of the temperature at the control panel using at least the second temperature and the third temperature each measured when the control panel is in the reduced operational mode. When the rate of increase of the temperature at the control panel is below a predetermined threshold temperature rate of increase, method 300 can include outputting an abnormal temperature warning at the control panel. And, when the rate of increase of the temperature at the control panel is above the predetermined threshold temperature rate of increase, method 300 can include outputting an abnormal temperature critical alert at the control panel.

Generally, when the rate of increase of the temperature at the control panel is below the predetermined threshold temperature rate of increase this can mean that the temperature at the control panel is increasing relatively slowly or not all. And, generally when the rate of increase of the temperature at the control panel is above the predetermined threshold temperature rate of increase this can mean that the temperature at the control panel is increasing relatively quickly and may thus be indicative of a more significant event at the control panel or in the ambient environment that is adjacent the control panel. Accordingly, the abnormal temperature critical alert can have a higher priority and be indicative of a more significant abnormal temperature condition at the control panel than the abnormal temperature warning.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising:
measuring a first temperature at a control panel using a temperature sensor included at a battery of the control panel;
when the first temperature at the control panel exceeds a predetermined threshold temperature, transitioning the control panel to a reduced operational mode;
when the control panel is in the reduced operational mode, measuring a second temperature at the control panel using the temperature sensor included at the battery of the control panel; and
when the second temperature at the control panel exceeds the predetermined threshold temperature, outputting an abnormal temperature notification at the control panel.

2. The method of claim 1, wherein the reduced operational mode of the control panel produces less heat locally at the control panel than a normal operational mode of the control panel.

3. The method of claim 1, wherein transitioning the control panel to the reduced operational mode includes at least one of: terminating charging of the battery, dimming a user interface at the control panel, reducing an operating frequency of processing circuitry at the control panel, and turning off a wireless transmitter at the control panel.

4. The method of claim 3, wherein transitioning the control panel to the reduced operational mode includes each of dimming the user interface at the control panel and reducing the operating frequency of processing circuitry at the control panel.

5. The method of claim 1, wherein the control panel is transitioned to the reduced operational mode both when the first temperature at the control panel exceeds the predetermined threshold temperature and after the control panel has determined a lack of an alarm condition.

6. The method of claim 1, wherein, when the second temperature at the control panel exceeds the predetermined threshold temperature, maintaining the control panel in the reduced operational mode.

7. The method of claim 1, further comprising:
when the control panel is in the reduced operational mode, measuring a third temperature at the control panel using the temperature sensor included at the battery of the control panel.

8. The method of claim 7, wherein when the third temperature at the control panel is below the predetermined threshold temperature, transitioning the control panel from the reduced operational mode to a normal operational mode, wherein the normal operational mode consumes more power than the reduced operational mode.

9. The method of claim 8, wherein the control panel is in the normal operational mode when the first temperature at the control panel is measured.

10. The method of claim 7, wherein when the third temperature at the control panel exceeds a second predetermined threshold temperature that is greater than the predetermined threshold temperature, shutting down operation of the control panel.

11. The method of claim 1, wherein the temperature sensor is a thermistor at the battery.

12. The method of claim 11, wherein the battery is a rechargeable battery, and wherein the thermistor is embedded at the battery to measure a temperature of the battery when the battery is being charged in addition to the temperature at the control panel.

13. The method of claim 12, wherein the first temperature at the control panel is measured when the battery is not being charged.

14. The method of claim 12, wherein the first temperature at the control panel is measured when the control panel has determined a lack of an alarm condition.

15. The method of claim 12, wherein battery is a backup battery.

16. The method of claim 1, wherein outputting the abnormal temperature notification at the control panel includes sending the abnormal temperature notification to a remote device.

17. The method of claim 1, wherein outputting the abnormal temperature notification at the control panel includes providing an abnormal temperature alert locally at the control panel.

18. The method of claim 1, further comprising:
when the control panel is in the reduced operational mode, measuring a third temperature at the control panel using the temperature sensor included at the battery of the control panel;
determining a rate of increase of the temperature at the control panel using at least the second temperature and the third temperature each measured when the control panel is in the reduced operational mode;
when the rate of increase of the temperature at the control panel is below a predetermined threshold temperature rate of increase, outputting an abnormal temperature warning at the control panel; and
when the rate of increase of the temperature at the control panel is above the predetermined threshold temperature rate of increase, outputting an abnormal temperature critical alert at the control panel.

19. A control panel comprising:
processing circuitry;
a battery coupled to the processing circuity; and
a temperature sensor at the battery and coupled to the processing circuitry,
wherein the processing circuitry is configured to:
receive, from the temperature sensor at the battery, a first temperature at the control panel,
when the first temperature at the control panel exceeds a predetermined threshold temperature, transition the control panel to a reduced operational mode,
when the control panel is in the reduced operational mode, receive, from the temperature sensor at the battery, a second temperature at the control panel, and
when the second temperature at the control panel exceeds the predetermined threshold temperature, output an abnormal temperature notification at the control panel.

20. The control panel of claim 19,
wherein the control panel further comprises a user interface coupled to the processing circuity, and
wherein the processing circuity is configured to transition the control panel to the reduced operational mode by each of dimming the user interface at the control panel and reducing an operating frequency of the processing circuitry at the control panel.
